(19) United States
(12) Patent Application Publication
(10) Pub. No.: US 2010/0138030 A1
(43) Pub. Date: Jun. 3, 2010

(54) SYSTEM AND METHOD FOR CALIBRATING A HANDLING DEVICE

(75) Inventors: Martin Kohlmaier, Medling (AT); Rainer Krappinger, Kaltenleuitgeben (AT)

Correspondence Address: Darby & Darby, P.O. Box 770, Church Street Station, New York, NY, 10008-0770, US

(73) Assignee: ABB AG, VIENNA (AT)

(21) Appl. No.: 12/446,428

(22) PCT Filed: Oct. 18, 2007
(86) PCT No.: PCT/EP07/09043

§ 371 Date: Dec. 30, 2009

(30) Foreign Application Priority Data
Oct. 19, 2006 (DE) 10 2006 049 957.3

(51) Int. Cl. G05B 19/401; G05D 3/20; G05B 19/19

(52) U.S. Cl. 700/173; 700/192; 700/190

(57) ABSTRACT

A system for calibrating a handling apparatus relative to a workpiece comprises a handling apparatus having at least one tool and at least one measuring arrangement configured to record at least one controlled variable; and a regulatory device configured to determine at least two faces in a multidimensional space and to provide a resultant line of intersection for the at least two faces as a trajectory coordinates using the at least one controlled variable when the at least one workpiece is moved by the at least one measuring arrangement, thereby providing an optimized trajectory profile for implementation.

This is a U.S. National Phase Application under 35 U.S.C. §371 of International Application No. PCT/EP2007/009043, filed on Oct. 18, 2007, which claims priority to German Patent Application No. DE 10 2006 049 957.3, filed on Oct. 19, 2006. The International Application was published in German on Apr. 24, 2008 as WO 2008/046620 A1 under PCT 21(2).

The present invention relates to a system and a method for calibrating a handling apparatus, particularly in relation to a workpiece to be machined or processed, for the purpose of process optimization.

In particular, the invention is also concerned with the automated post- and further-processing of castings, for example, using a handling apparatus, regardless of the material or the production method for the further production process.

### BACKGROUND

Casting methods for producing workpieces are widely used in industrial production and are the technical standard in many areas. Probably the best-known and also oldest form of casting is metal casting. This type of casting has become more and more refined and specialized in recent years on account of technical developments. Other materials such as plastic have been added. This production process has become economically so significant that it is a separate area within casting science and is usually referred to as injection molding.

The enormous spread and increasing use of castings of whatever type and of whatever production method attribute ever greater priority to the demand for automation concepts, which cover almost the entire production process. This also means that the reworking of castings and/or injection-molded parts is becoming increasingly significant. In this area, automation is always opening up new opportunities in comparison with manual machining, particularly as far as throughput, productivity, quality and production costs are concerned. Fully-automatic, reproducible processes allow product quality and production constancy to be significantly increased and/or raised in comparison.

The two most frequent machining processes during the reworking of castings and/or injection-molded parts are
the milling of complex 3D molds by robots,
the deburring of complex 3D castings by robots.

Owing to the production process, the production tolerance for castings is more or less pronounced. In this context, reworking particularly of edges fulfills the purpose of bringing the dimensions of the casting within the tolerances which are needed for the further production process. In this case, orienting the workpiece relative to the tool is already a first obstacle, since the respective robot program or control program actuates position points in the space and it is often not possible to ensure sufficiently exact positioning of the workpiece simply on account of the production tolerances and/or irregularities.

A further difficulty concerns the greatly varying appearance of excess casting on the workpiece itself. The material which needs to be taken off or removed from the workpiece during the deburring process, for example, thus also varies in terms of quantity.

In conventional systems, the robot program and/or control program is created directly from the CAD drawing of the respective workpiece. If such a CAD drawing is unavailable, however, the programs are created on a prototype part, also called “master part”, which already represents the final shape and geometry of the workpiece, for example using the “teach-in” method and/or by means of manual coordinate input. These methods are usually extremely time consuming and/or error prone, and the quality of the later produced parts can only be as good as the master part itself.

Calibration between the tool and the workpiece, including to determine the actual situation and/or orientation of the workpiece, is usually performed, at least in part, manually by calibrating the object being machined and the tool operating point.

Gauging by means of laser to update the operating point of the handling apparatus, for example during the automated welding process, is also known.

Industrial image processing can also be used to machine casting tolerances on a casting by integrating camera systems for trajectory correction for handling apparatuses. In this case, faces or planes for machining are calculated from the digital information of the vision system (image processing system) and are forwarded as position data to the robot. However, this presupposes that the position of the digital image processing appliance or combination has been gauged relative to the tool and these coordinates are taken into account in the program sequence. The slightest discrepancy as a result of measurement errors in the camera system or in the calibration can render the workpiece unusable during machining.

The aforementioned difficulties arise in different forms in the respective machining methods.

### SUMMARY OF THE INVENTION

An aspect of the present invention is to provide a way of avoiding the aforementioned drawbacks as far as possible when calibrating a handling apparatus and of extending the scope of application of industrial handling systems.

Advantageous embodiments and developments of the system according to the invention and a method for calibrating a handling apparatus are specified in the claims and in the description which follows.

The aforementioned system for calibrating a handling apparatus includes a handling apparatus, particularly a robot, and at least one tool or at least one workpiece arranged thereon, and also at least one measuring arrangement for recording at least one controlled variable, wherein a regulatory device is provided which, when a workpiece is traversed with the measuring arrangement, the tool and the workpiece interacting, uses the at least one controlled variable to determine at least two faces in a multidimensional space and provides a control device with the resultant line of intersection for said faces as trajectory coordinates for an optimized trajectory profile for implementation.

It is also advantageously possible to provide a control device for process control and/or motion control for the handling apparatus.

In one advantageous embodiment of the invention, at least one interface for wired or wireless communication and/or data transmission is provided which can be used to transmit the trajectory coordinates provided and/or the optimized trajectory profile to the control device of the handling apparatus for implementation.

In another embodiment, the regulatory device can be integrated into the control device and/or is in the form of part of the control device, wherein alternatively the regulatory device can also be integrated into the measuring arrangement and/or may be in the form of part of the measuring arrangement.

Advantageously, determining the trajectory coordinates and/or the optimized trajectory profile allows calibration of the tool relative to the workpiece.

In one development of the system, the respective machining and/or processing process is executed one or more times, taking account of predeterminable parameters, until the respective machining trajectory of the tool and/or the handling apparatus that is currently being executed corresponds to the optimized trajectory profile ascertained using the line of intersection for the faces, so that the final geometry of the workpiece following machining and/or processing is within predeterminable tolerances.

It is advantageously possible to use a multiple-axis handling apparatus, particularly a six-axis handling apparatus, such as a six-axis industrial robot, or a single-axis handling apparatus, wherein—in one development of the system—the coordinate or reference system of at least one axis of the handling apparatus can be used as a reference for determining the trajectory coordinates and/or trajectory curve.

In particular, advantageously, the handling apparatus can be calibrated with respect to the workpiece to be machined and/or the trajectory coordinates for obtaining an optimized trajectory profile can be determined prior to and/or during the machining and/or processing process.

In one development of the system, the calibration can also be performed continuously or cyclically or discontinuously, particularly on the basis of predeterminable parameters and/or ambient conditions, for example on the basis of position and/or situation and/or under the influence of edges, material transitions, surface roughnesses, with the calibration operation particularly also being able to be executed or being executed under program control.

In this case, at least one measuring arrangement is arranged particularly at the distal end of the handling apparatus, with at least one measuring arrangement at the distal end of the handling apparatus also being able to be arranged between the handling apparatus and the respective tool and/or physically connected to these.

Provision may also be made for a holding apparatus to be provided for holding at least one tool or at least one workpiece and/or to be arranged at the distal end of the handling apparatus, wherein particularly also at least one measuring arrangement arranged at the distal end of the handling apparatus is or can be physically connected to the holding apparatus.

The connection may in this case particularly be in the form of a screw, weld, clamping, bayonet, magnetic or flange joint.

In one preferred embodiment, at least one measuring arrangement has at least one sensor for recording forces and/or moments and/or force and/or moment differences, with particularly one of the following types of sensor being used:

piezoelectric sensor; in a piezoelectric sensor, pressure, that is to say force per area, is used to produce an electrical voltage in a crystal, with electrical charges being isolated in the crystal (piezoelectric effect). In this case, the electrical voltage changes in a predetermined range in proportion to the force. This effect also works the other way around, so that applying an electrical voltage to the piezoelectric sensor causes the latter to deform. Furthermore, piezoelectric sensors afford several advantages, for example they are insensitive toward high temperatures, no external power supply is required and their efficiency is comparatively high.
force transducer; when force transducers are used, action of force causes a spring element to elastically deform, the force needing to be taken up in a prescribed direction. The deformation of the spring body, usually metal, which is brought about by the action of force is converted into electrical voltage by means of expansion measuring strips. An appropriately providable measurement amplifier, for example, is then used to register the electrical voltage brought about by the action of force and hence the expansion change, and/or said electrical voltage and hence expansion change can be converted into a force measured value on the basis of the elastic properties of the spring body.

differential pressure gauge; this measures the difference between two absolute pressures, what is known as the differential pressure. The differential pressure sensor may have two measuring chambers which are hermetically isolated from one another by a diaphragm. The measurable deflection in the diaphragm is then a measure of the size of the differential pressure. The chambers may be filled with liquid, particularly also with a gel of appropriate viscosity.

In one embodiment of the system, at least one measuring arrangement for determining forces and/or moments or for determining force and/or moment differences is arranged in the region of at least one of the axes or axes of rotation of the handling apparatus.

The system may have provision for at least one measuring arrangement to be in the form of part of the kinematics or of the kinematic system and/or of the moving apparatus in the handling apparatus.

It is also possible to provide for recorded controlled-variable measured values and/or the respective measurement signal, formed or resulting therefrom, from at least one measuring arrangement to be output and/or forwarded as absolute values.

Alternatively, it is possible to provide for the relevant values and/or signals to be output and/or forwarded as relative values.

It is also advantageously possible to provide for the recorded controlled-variable measured values and/or the respective resultant measurement signal to be output and/or forwarded as an analog or digital signal, with, in particular, appropriate interfaces needing to be provided in the form of a D/A and/or A/D converter, for example.

In a further form of the system, provision may also be made for controlled-variable measured values and/or trajectory coordinates of an optimized trajectory profile and/or trajectory correction data to be transmitted to the control device of the handling apparatus by means of a superordinate management or control system and/or network.

In addition, the system may have provision for controlled-variable measured values and/or the measurement signal obtained or resulting therefrom to be forwarded to the control device of the handling apparatus by means of an external control system.

In one advantageous embodiment, measurement or recording of physical variables, particularly of relevant process variables, is prompted from the process, that is to say during the calibration and/or machining or processing of at least one workpiece.

The system may have provision for the recorded controlled-variable measured values to be able to be used, with the measuring arrangement, the regulatory device and the control device interacting, to perform changes of trajectory very flexibly and/or in comparatively short times.

The recorded controlled variable may be a single- or multidimensional variable, for example a vectorial variable, particularly a force vector, or may be a coordinate point in a three-dimensional space.

In one development of the system, the controlled-variable measured values and/or the resultant measurement signal may also be used for absolute calibration of the handling apparatus.

Machining angles which arise between the tool and the workpiece to be machined can also advantageously be taken into account and/or have no influence on the measuring arrangement and the regulatory device.

In particular, the operation of the measuring arrangement and the regulatory device is independent of the relative motion and/or relative speed of the tool in relation to the workpiece to be machined.

In addition, the stated object is also achieved by an appropriate method for calibrating a handling apparatus having the features of claim 32.

In line with the method, at least one measuring arrangement, arranged on a handling apparatus, and a tool are used to record at least one controlled variable when a workpiece is traversed and, with the measuring arrangement, the tool and the workpiece interacting, a regulatory device is used to determine at least two faces of the workpiece in a multidimensional space from the recorded controlled-variable measured values, and the resultant line of intersection is used to ascertain trajectory coordinates for an optimized trajectory profile and/or to provide them for implementation.

In one embodiment of the method, the at least one controlled variable and formation of the line of intersection are recorded by traversing adjacent and/or bordering contour and/or surface regions of the respective workpiece one or more times, it being particularly possible to provide an offset between two traversed trajectories.

In addition, provision may be made for the controlled variable recorded to be the force and/or moment acting in at least one predeterminable direction between the tool and the workpiece and/or the differences in said force and/or moment in relation to at least one predeterminable reference value.

In particular, the contact force or bearing force between the workpiece and the tool is recorded and/or, in a development of the method, is regulated to a predeterminable reference value.

Alternatively, the orientation of the tool and/or of the workpiece can be taken into account, particularly using angle transmitter information from the handling apparatus, in order to determine a face in a multidimensional space or reference system even after a respective contour and/or surface region has been traversed just once.

It is also possible to provide for the workpiece or a contour and/or surface region to be traversed automatically.

It is also advantageously possible to provide for a control device to be used for the process control and/or motion control for the handling apparatus.

As a basis for the automated traversing, it is advantageously possible to provide, in preparation for the method, for the contour and/or surface profile to be recorded approximately by manual and/or semiautomatic traversing and/or guidance and/or scanning of the workpiece by means of the tool and/or for the control device of the handling apparatus to be trained.

In line with the method, provision may be made for at least one interface for wired or wireless communication and/or data transmission to be used which is used to transmit the provided trajectory coordinates and/or the respective optimized trajectory profile to the control device of the handling apparatus for implementation.

Advantageously, the tool can be calibrated relative to the workpiece by determining the trajectory coordinates and/or the optimized trajectory profile.

In one development of the method, the respective machining and/or processing process is executed one or more times, taking account of predeterminable parameters, until the respective currently executed machining trajectory for the tool and/or the handling apparatus corresponds to the trajectory profile ascertained using the line of intersection for the faces, so that the final geometry of the workpiece following machining and/or processing is within predeterminable tolerances.

The method has provision for a multiple-axis handling apparatus, particularly a six-axis handling apparatus, for example a six-axis industrial robot, or a single-axis handling apparatus to be able to be used.

In addition, provision may be made for the coordinate system and/or reference system for at least one axis of the handling apparatus to be used as a reference for determining the trajectory coordinates and/or the trajectory curve.

A further embodiment of the method provides for the handling apparatus to be calibrated with respect to the workpiece to be machined and/or for the trajectory coordinates for obtaining an optimized trajectory profile to be determined prior to and/or during the machining and/or processing process.

In a further variant embodiment, the handling apparatus is calibrated with respect to the workpiece to be machined and/or the trajectory coordinates for obtaining an optimized trajectory profile are determined continuously or cyclically or discontinuously, particularly on the basis of predeterminable parameters.

In line with the method, the handling apparatus can advantageously be calibrated with respect to the workpiece to be machined under program control and/or on a parameter basis.

In one embodiment of the method, the controlled-variable measured values are recorded by means of at least one measuring arrangement arranged at the distal end of the handling apparatus, with it alternatively also being possible to use a measuring arrangement which is arranged at the distal end of the handling apparatus between the handling apparatus and the tool and/or is physically connected to these.

The method may have provision for a measuring arrangement having at least one sensor for recording forces and/or moments and/or force and/or moment differences to be used.

In another embodiment, a holding apparatus is used for holding at least one tool or at least one workpiece and/or is arranged at the distal end of the handling apparatus.

It is also possible to provide for at least one measuring arrangement arranged at the distal end of the handling apparatus to be physically connected to the holding apparatus.

In another embodiment, the controlled-variable measured values and/or the respective resultant measurement signal from at least one measuring arrangement are output as absolute values.

In another embodiment of the method, controlled-variable measured values and/or the measurement signal formed or resulting therefrom are output as relative values.

It is also advantageously possible to provide for controlled-variable measured values and/or the respective resultant measurement signal to be output as an analog or digital signal.

In addition, provision may be made for controlled-variable measured values and/or trajectory coordinates of an optimized trajectory profile and/or trajectory correction data to be transmitted to the control device of the handling apparatus by means of a superordinate management or control system and/or network.

Provision may also be made for recorded controlled-variable measured values and/or the resultant measurement signal to be forwarded to the control device of the handling apparatus or of the handling appliance by means of an external control system.

Additionally, provision may be made for dynamic measured variables to be ascertained.

The method may also have provision for the recorded controlled-variable measured values to be used to execute changes of trajectory flexibly when the measuring arrangement and the control device interact.

Provision may also be made for the controlled variable to be ascertained as a single- or multidimensional variable, particularly as a vectorial variable.

In another embodiment of the method, the handling appliance can also be calibrated absolutely using the controlled-variable measured values and/or the resultant measurement signal.

The method may have provision for machining angles which arise between the tool and the workpiece to be machined to be taken into account and/or utilized and/or to have no influence on the measuring arrangement and the regulatory device.

The invention particularly allows machining to take place in reproducible single steps directly after production, regardless of the actual geometry of the workpiece. In this case, it should be highlighted that the use of sensor technology for measuring the actual contact force between the tool and the workpiece to be machined in the multidimensional space allows the speed of the tool to be regulated to an optimum value at any time by the control device of the handling apparatus.

The fact that the combination, fitted to the handling apparatus, of sensor technology implemented in the measuring arrangement and a tool also determines the required faces for ascertaining the machining trajectory means that there is no need for an additional measuring device, used for calibration, of any kind whatsoever which currently needs to perform this function additionally and externally in order to control the handling apparatus.

It is thus possible for the different tasks and functions to be performed prior to and during the machining and to compensate for tolerances in the workpiece during production. By avoiding additional sensors, further costs for setting up these machining cells are avoided.

For the rest of the description, the focus of the explanations will be on the deburring of metal castings. Other machining methods are similarly covered, however.

### BRIEF DESCRIPTION OF THE DRAWINGS

The invention and advantageous developments are illustrated further with reference to a few figures and the exemplary embodiments, in which:

FIG. 1 shows an example system design for calibrating a handling apparatus with a workpiece with an optimized trajectory curve, determined in line with the method, for a deburring tool;

FIG. 2 shows a sectional illustration of a workpiece with two burrs and an optimized trajectory curve ascertained in line with the method; and

FIG. 3 shows a 3-dimensional illustration of a workpiece with an optimized trajectory curve ascertained in line with the method.

### DETAILED DESCRIPTION

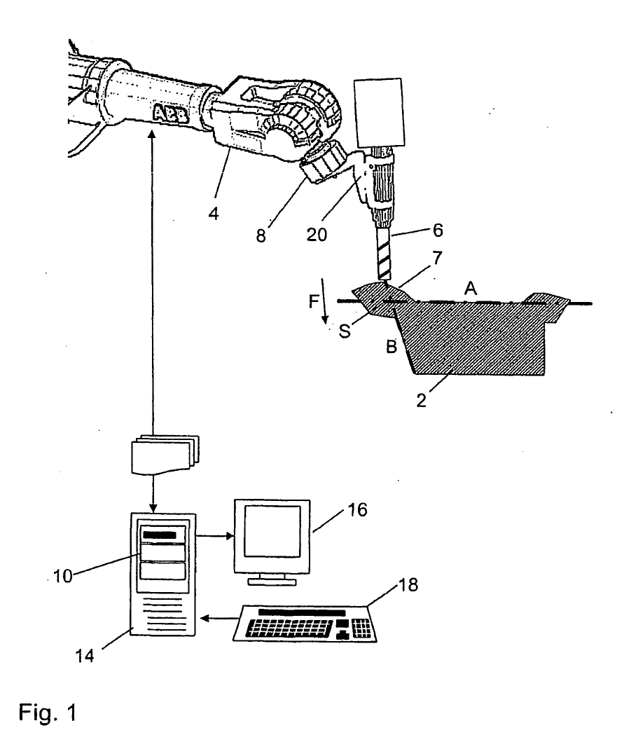

FIG. 1 shows an example system design according to the invention and a workpiece 2 which is to be deburred and which has an optimized trajectory curve, determined in line with the method, for a robot 4 with a deburring tool 6. The illustration is not to scale. To calibrate the robot 2 with the deburring tool 6 relative to the workpiece 2 with the burr 7, at least one measuring arrangement 8, arranged on the robot 2, with at least one force sensor for recording the bearing force F or contact force between the deburring tool 6 and the workpiece 2 is used to record the contact force when the workpiece 2 is traversed, and, with the measuring arrangement 8, the tool 6 and the workpiece 2 interacting, a regulatory device 10 is used to determine at least two faces A, B of the workpiece 2 and the line of intersection S for said faces in the 3-dimensional space from the recorded force measured values, and the trajectory coordinates for a trajectory profile which is optimized for deburring is ascertained on the basis of the line of intersection S and is transmitted to the control device 14 for the robot 4 for implementation. In this case, the control device 14 also comprises a display device 16 and an input device 18, for example for the purpose of parameter input. The system is also provided with a holding apparatus 20 for holding the deburring tool 6.

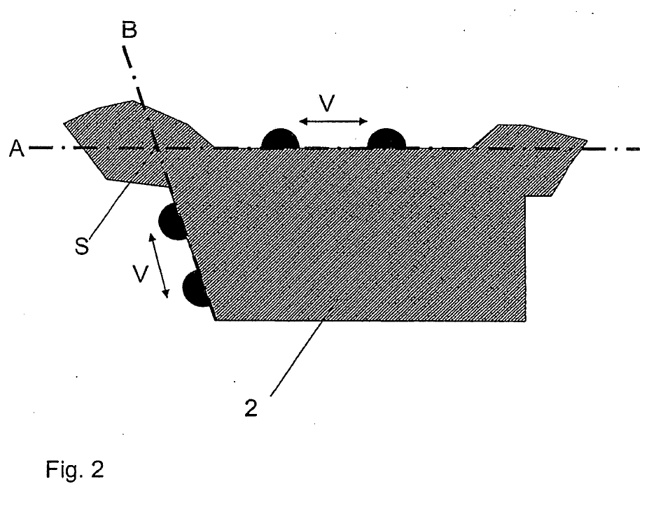

As FIG. 2 shows, adjacent and/or bordering contour and/or surface regions of the respective workpiece 2 are traversed at least twice with an offset V or interval from one another in order to obtain the faces A, B and determine the line of intersection S.

The workpiece 2 is machined, particularly deburred, automatically, and the robot 4 with the deburring tool 6 and the measuring arrangement 8, arranged between the distal end of the robot 4 and the deburring tool 6, with force sensors for recording the contact forces F between the tool 6 and the workpiece 2 attempts to achieve the optimized trajectory curve S by repeatedly traversing the workpiece 2 with the deburrer 6.

In this case, the respective machining and/or processing process is also continually optimized taking account of the recorded contact forces F.

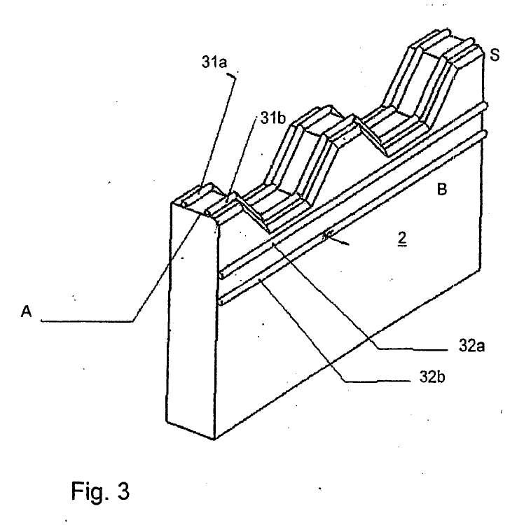

FIG. 3 shows a corresponding workpiece 2 with two faces A, B with two respective traversing trajectories 31a, 31b and 32a and 32b and the line of intersection S or optimized trajectory curve which is obtained from the faces.

1-60. (canceled)

61. A system for calibrating a handling apparatus relative to a workpiece comprising:
a handling apparatus having at least one tool and at least one measuring arrangement configured to record at least one controlled variable; and
a regulatory device configured to determine at least two faces in a multidimensional space and to provide a resultant line of intersection for the at least two faces as trajectory coordinates using the at least one controlled variable when the at least one workpiece is moved by the at least one measuring arrangement, thereby providing an optimized trajectory profile for implementation.

62. The system as recited in claim 61, further comprising a control device configured to provide at least one of a process control and a motion control to the handling apparatus.

63. The system as recited in claim 61, wherein providing of the optimized trajectory profile is used to calibrate the at least one tool relative to the workpiece.

64. The system as recited in claim 61, wherein the handling apparatus is configured to carryout the trajectory profile so as to cause a final geometry of the workpiece to have predeterminable tolerances.

65. The system as recited in claim 61, wherein the handling apparatus is configured to be calibrated with respect to the workpiece to be machined and the trajectory coordinates used to obtain the optimized trajectory profile are configured to be determined prior to or during operation of the handling apparatus.

66. The system as recited in claim 65, further comprising a program control.

67. The system as recited in claim 61, wherein the at least one measuring arrangement is disposed at a distal end of the handling apparatus.

68. The system as recited in claim 67, wherein the at least one measuring arrangement is disposed between the handling apparatus and the at least one tool or is physically connected to the handling apparatus and the at least one tool.

69. The system as recited in claim 61, wherein the at least one measuring arrangement includes at least one sensor for recording at least one of a force, a moment, a force difference, and a moment difference.

70. The system as recited in claim 67, further comprising a holding apparatus disposed at the distal end of the handling apparatus and configured to hold the at least one tool.

71. The system as recited in claim 70, wherein the at least one measuring arrangement is physically connected to the holding apparatus.

72. The system as recited in claim 61, wherein the system is configured to ascertain a dynamic measured variable.

73. The system as recited in claim 61, wherein recorded controlled-variable measured values are configured to be used to execute a flexible change of trajectory when the measuring arrangement and the control device interact.

74. The system as recited in claim 61, wherein the controlled variable includes one of a single- and a multidimensional variable.

75. A method for calibrating a handling apparatus comprising:
recording at least one controlled variable when a workpiece is moved using at least one measuring arrangement and a tool disposed on a handling apparatus;
determining at least two faces of the workpiece in a multidimensional space from recorded controlled-variable measured values using a regulatory device when the tool, workpiece, and measuring device interact;
determining a resultant line of intersection from the at least two faces; and
ascertaining trajectory coordinates based on the resultant line of intersection for an optimized trajectory profile.

76. The method as recited in claim 75, further comprising traversing adjacent or bordering contour or surface regions of the respective workpieces one or more times with an offset and recording the at least one controlled variable and formation of a line of intersection.

77. The method as recited in claim 75, further comprising operating the handling apparatus based on the optimized trajectory profile to provide a final geometry of the workpiece within a predeterminable tolerance.

78. The method as recited in claim 75, further comprising disposing the at least one measuring arrangement at the distal end of the handling apparatus.

79. The method as recited in claim 78, wherein the at least one measuring arrangement is disposed between the handling apparatus and the at least one tool.

80. The method as recited in claim 75, wherein the recording of the at least one variable includes recording at least one of a force, a moment, a force difference, and a moment difference using at least one sensor of the measuring arrangement.

81. The method as recited in claim 75, further comprising measuring physical variables resulting from a process of the handling apparatus.

82. The method as recited in claim 75, further comprising ascertaining dynamic measured variables.

83. The method as recited in claim 75, wherein operation of the at least one measuring arrangement and the regulatory device is not influenced by a relative motion or relative speed of the at least one tool relative to the workpiece.
